(19) United States
(12) Patent Application Publication
(10) Pub. No.: US 2017/0212483 A1
(43) Pub. Date: Jul. 27, 2017

(54) NUMERICAL CONTROL SYSTEM USING DATA ANALYZED BY MACHINING SIMULATION IN ACTUAL MACHINING

(71) Applicant: FANUC CORPORATION, Minamitsuru-gun (JP)

(72) Inventors: Kenji Tanaka, Minamitsuru-gun (JP); Yorikazu Fukui, Minamitsuru-gun (JP)

(73) Assignee: FANUC CORPORATION, Minamitsuru-gun (JP)

(21) Appl. No.: 15/409,984

(22) Filed: Jan. 19, 2017

(30) Foreign Application Priority Data
Jan. 26, 2016 (JP) 2016-012475

(51) Int. Cl. G05B 13/04

(52) U.S. Cl. CPC G05B 13/042

(57) ABSTRACT

A numerical control system includes a numerical controller that controls a machine based on a program, and a machining simulation device that executes a machining simulation process of the program. The machining simulation device analyzes the program and stores machining information acquired from the result of analysis. The numerical controller performs processes such as machining restart, interference check, and path drawing using the stored machining information.

### BACKGROUND OF THE INVENTION

1. Field of the Invention

The present invention relates to a numerical control system, and more particularly to a numerical control system in which data acquired by machining simulation is used in actual machining.

2. Description of the Related Art

A numerical controller performs machining while analyzing a machining program to create machining information. Restart of machining half way through a program, due to suspension or the like of machining, is made possible by analyzing the program once again from the beginning or by storing, in a memory during execution of the program, information necessary for restarting machining (see, for example, Japanese Patent Application Laid-Open No. 2015-153063).

In the technique disclosed in Japanese Patent Application Laid-Open No. 2015-153063, drawing a machining path based on the program is executed on the numerical controller. Moreover, interference check for a tool, a jig, and the like is implemented by comparing positions of a tool and information relating to an interfering object while executing a program (see, for example, Japanese Patent Application Laid-Open No. 2010-231737).

When restarting machining half way through, it is necessary to store machining information relating to a block, at which to restart machining, in a memory inside the numerical controller, and the memory capacity constitutes a limitation. When a function such as interference check is performed in combination with the execution of machining, it is necessary to check interference for each item of machining information that is created when performing machining, and a large load is placed on a CPU of the numerical controller.

When realizing a function of drawing the path of a tool, a machining program is analyzed similarly to actual machining such that the path is drawn while machining information is being created. Due to this, when the path of a tool is drawn during execution of machining, an analysis process for actual machining and an analysis process for path drawing are performed separately, and the load on the numerical controller is approximately twice that when a tool path is not drawn. When performing machining using the created machining program, it is not known until actually performing same whether or not an error occurs during execution of machining. This means that when an error occurs during execution of machining, correction of the machining program and execution of machining are repeated one after the other, thus requiring a considerable amount of time until it becomes possible to carry out machining to the end without errors.

### SUMMARY OF THE INVENTION

Therefore, it is an object of the present invention to provide a numerical control system capable of alleviating a load on a CPU of a numerical controller and reducing a processing time.

The present invention solves the above-described problem by providing a system which alleviates the load on a CPU of a numerical controller and reduces a processing time by using, during execution of machining, machining information which is necessary for machining operation and is created in advance by a machining simulation device analyzing a machining program.

A numerical control system according to the present invention includes: a numerical controller that controls a machine based on a program; a machining simulation device that executes a machining simulation process of the program; and a machining information storage unit that stores machining information used when machining is performed based on the program. The machining simulation device includes: a setting data acquisition unit that acquires information necessary for the machining simulation process of the program from the numerical controller; a program analysis unit that analyzes the program based on the information acquired by the setting data acquisition unit; a machining information acquisition unit that acquires machining information, which is information necessary for machining, from a result of the analysis by the program analysis unit; and a machining information storing unit that stores the machining information acquired by the machining information acquisition unit in the machining information storage unit. The numerical controller includes: an analysis information acquisition unit that acquires the machining information from the machining information storage unit; and a reconstituting unit that reconstitutes information used for actual machining based on the machining information acquired by the analysis information acquisition unit.

The analysis information acquisition unit may acquire machining information associated with a starting block at which execution of the program starts, the machining information being stored in the machining information storage unit, the reconstituting unit may reconstitute information used for execution of the program based on the machining information acquired by the analysis information acquisition unit, and the numerical controller may start machining based on the program from the starting block based on the information reconstituted by the reconstituting unit.

The numerical controller may further include a checking information applying unit, the analysis information acquisition unit may acquire machining information associated with at least one block subject to an interference checking process of the program, the machining information being stored in the machining information storage unit, the checking information applying unit may apply information included in the machining information acquired by the analysis information acquisition unit to information used for the interference checking process, and the numerical controller may perform interference check on the block subject to the interference checking process based on the information used for the interference checking process to which the machining information is applied by the checking information applying unit.

The numerical controller may further include a drawing information applying unit, the analysis information acquisition unit may acquire machining information associated with at least one block subject to a path drawing process of the program, the machining information being stored in the machining information storage unit, the drawing information applying unit may apply information included in the machining information acquired by the analysis information acquisition unit to information used for the path drawing process, and the numerical controller may draw a path of the block subject to the path drawing process based on the information used for the path drawing process to which the machining information is applied by the drawing information applying unit.

The machining information acquisition unit may acquire information on an error occurring when the program analysis unit analyzes the program as one item of the machining information, and the numerical controller may check an error of the program based on the error information included in the machining information.

The machining simulation device and the numerical controller may be connected by a dedicated interface, the machining information storage unit may be provided on a memory included in the machining simulation device, and the machining simulation device may further include an analysis information transmission unit that transmits the machining information stored in the machining information storage unit to the analysis information acquisition unit.

The numerical controller may include at least two execution entities, the machining simulation device may be implemented inside the numerical controller, execution of the program by the numerical controller and the machining simulation process of the program by the machining simulation device may be executed by the execution entities differing from one another, and the machining information storage unit may be provided on a shared memory in the numerical controller.

In the numerical control system of the present invention, since the machining information acquired in advance by analyzing the machining program can be stored in a memory different from the memory in the numerical controller, no limitation is imposed on the numerical controller. Moreover, by using the machining information acquired in advance by analyzing the machining program in the interference check, it is possible to alleviate the load on the CPU of the numerical controller when interference check is performed in combination with actual machining.

Moreover, by using the machining information acquired by analyzing the machining program in advance in the path drawing, it is possible to alleviate the load on the numerical controller when path drawing is performed in combination with actual machining. Furthermore, by storing error information in machining information when analyzing the machining program in advance, it is possible to know the presence of the occurrence of an error when the numerical controller selects the machining program, and therefore it is possible to check errors before machining, enabling more efficient programming.

### BRIEF DESCRIPTION OF THE DRAWINGS

FIG. 1 is functional block diagram of a numerical control system according to an embodiment of the present invention;

FIG. 2 is a diagram illustrating an example in which the numerical control system illustrated in FIG. 1 is implemented by one numerical controller;

FIG. 3 is a diagram illustrating an operation image of a numerical control system according to Embodiment 1 of the present invention;

FIG. 4 is a schematic functional block diagram of the numerical control system according to Embodiment 1 of the present invention;

FIG. 5 is a schematic flowchart of a process associated with a program analysis executed by a machining simulation device of the numerical control system illustrated in FIG. 4;

FIG. 6 is a schematic flowchart of a process associated with transmission of machining information performed by the machining simulation device of the numerical control system illustrated in FIG. 4;

FIG. 7 is a schematic functional block diagram of the numerical controller illustrated in FIG. 4;

FIG. 8 is a schematic flowchart of a process executed on the numerical controller illustrated in FIG. 7;

FIG. 9 is a schematic functional block diagram of a numerical controller included in a numerical control system according to Embodiment 2 of the present invention;

FIG. 10 is a schematic flowchart of a process executed on the numerical controller illustrated in FIG. 9;

FIG. 11 is a schematic functional block diagram of a numerical controller included in a numerical control system according to Embodiment 3 of the present invention; and

FIG. 12 is a schematic flowchart of a process executed on the numerical controller illustrated in FIG. 10.

### DETAILED DESCRIPTION OF THE PREFERRED EMBODIMENTS

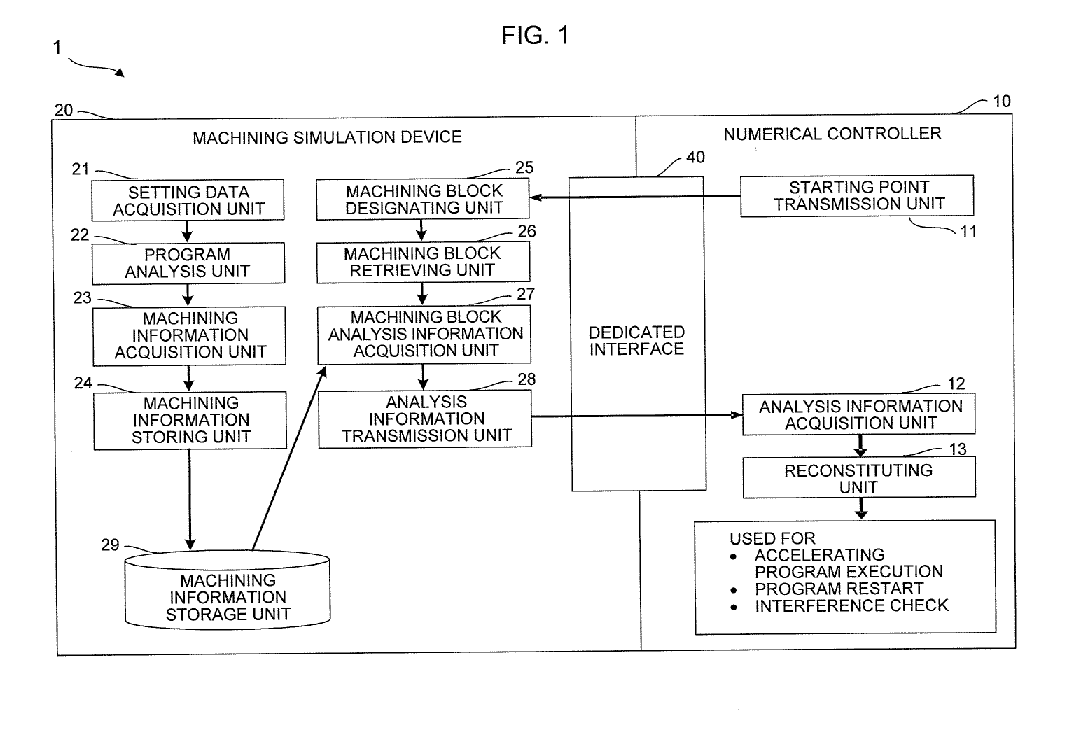

FIG. 1 is a functional block diagram of a numerical control system according to an embodiment of the present invention.

As illustrated in FIG. 1, a numerical control system according to the present embodiment includes a machining simulation device 20 that creates machining information by a machining simulation process that analyzes a machining program similarly to a numerical controller 10 and the numerical controller 10 capable of performing machining using the machining information created by the machining simulation process.

The machining simulation device 20 includes a setting data acquisition unit 21 that acquires information such as parameters required for machining, a tool correction amount, and a machining program from the numerical controller 10, a program analysis unit 22 that analyzes the machining program similarly to the numerical controller 10, a machining information acquisition unit 23 that acquires machining information required for machining from the data analyzed by the program analysis unit 22, a machining information storing unit 24 that stores the acquired machining information in a machining information storage unit 29 provided on a memory (a volatile memory or a nonvolatile memory), a machining block designating unit 25 that receives a designation of a machining block on the machining program from the outside, a machining block retrieving unit 26 that retrieves information on the designated machining block, a machining block analysis information acquisition unit 27 that acquires machining information relating to a machining block retrieved by the machining block retrieving unit 26 from the machining information storage unit 29, and an analysis information transmission unit 28 that transmits the machining information relating to the machining block acquired by the machining block analysis information acquisition unit 27 to the numerical controller.

Moreover, the numerical controller 10 includes a starting point transmission unit 11 that transmits, to the machining simulation device 20, a starting point at which an analysis on the machining program is to be started, an analysis information acquisition unit 12 that acquires the set machining information from the machining simulation device 20, and a reconstituting unit 13 that reconstitutes the acquired machining information so as to be used in actual machining.

The machining simulation device 20 and the numerical controller 10 exchange the starting point, the machining information, and the like via a dedicated interface 40.

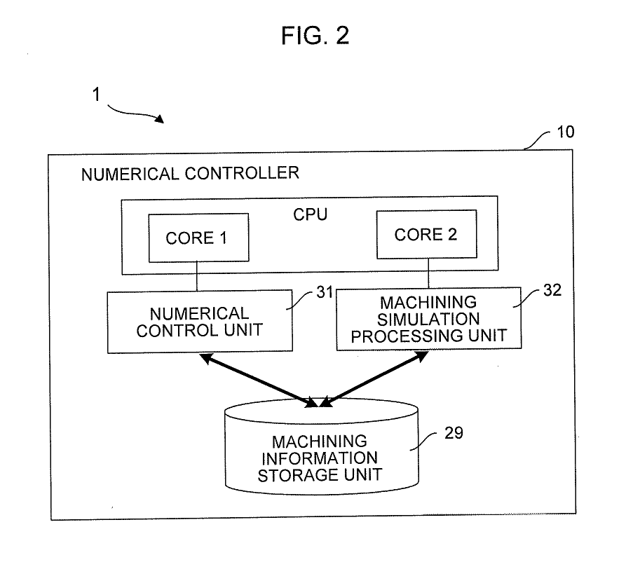

In the numerical control system 1 of the present embodiment, the machining simulation device 20 is implemented by a personal computer and is cooperated with the numerical controller 10 via the dedicated interface 40. However, for example, as illustrated in FIG. 2, a machining simulation processing unit 32 may be provided separately from a numerical control unit 31 in the numerical controller 10 so that the machining simulation processing unit 32 executes the machining simulation process. In this case, the machining simulation process may be executed by an execution entity different from an execution entity used by the numerical control unit 31 using the numerical controller 10 on which a plurality of execution entities is mounted like a plurality of CPUs or a CPU having a plurality of cores so that the machining simulation process executed by the machining simulation processing unit 32 does not interfere the numerical control process of the numerical control unit 31. By doing so, since the machining simulation process can be performed without any adverse effect on the numerical control process, the machining simulation process can be used as a background function of the numerical controller 10. Furthermore, by providing both the numerical control unit 31 and the machining simulation processing unit 32 in one numerical controller 10 and providing the machining information storage unit 29 in a memory (a volatile memory or a nonvolatile memory) shared by both units, the machining information can be exchanged easily.

In the numerical control system 1 of the present embodiment, by applying the machining information acquired by the analysis information acquisition unit 12 of the numerical controller 10 to information necessary for an interference check function included in the numerical controller 10, it is possible to realize interference check.

Moreover, by applying machining information acquired by the analysis information acquisition unit 12 of the numerical controller 10 to information necessary for a path drawing function included in the numerical controller 10, it is possible to realize a drawing function.

Furthermore, when the machining program is analyzed by the program analysis unit 22, and an error is detected, the error information is embedded in machining information, and error check can be performed by reading the error information from the machining information acquired by the analysis information acquisition unit 12 of the numerical controller 10.

Hereinafter, embodiments of the numerical control system 1 of the present invention will be described.

### Embodiment 1

Embodiment 1 of the numerical control system 1 of the present invention will be described below with reference to FIGS. 3 to 7. The numerical control system of this embodiment is used to restart a program. An overall image of the present embodiment is illustrated in FIG. 3.

In the numerical control system 1 of the present embodiment, the machining simulation device 20 analyzes a machining program in advance to create machining information and stores the machining information in the machining information storage unit 29. By using the machining information stored in the machining information storage unit 29 of the machining simulation device 20 when the numerical controller 10 starts machining, it is possible to start machining from an arbitrary block in the machining program.

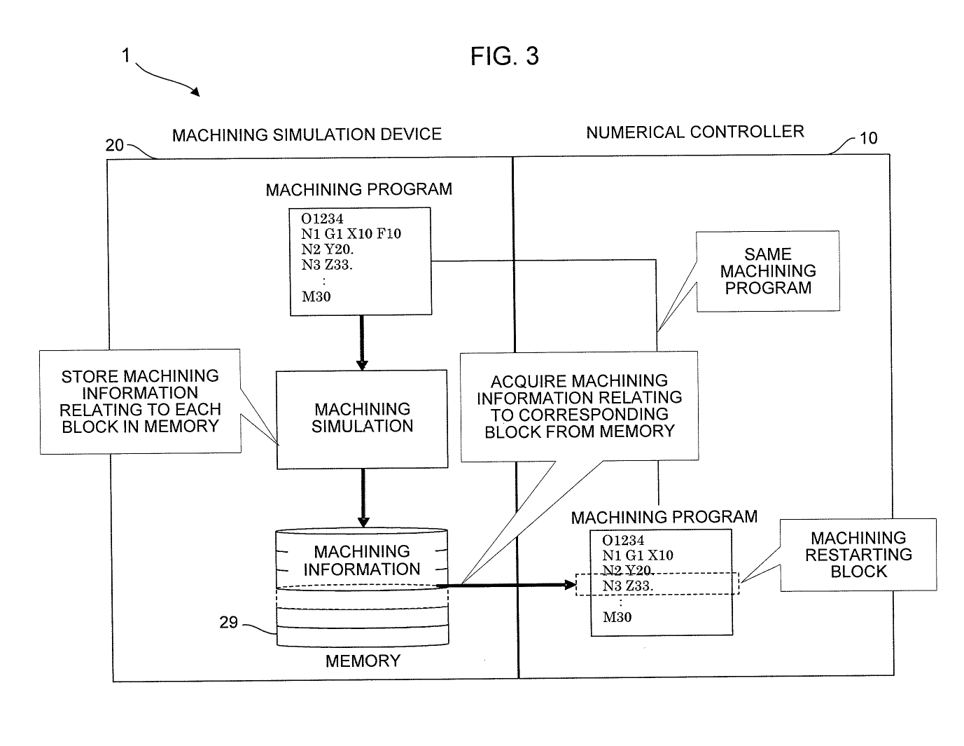

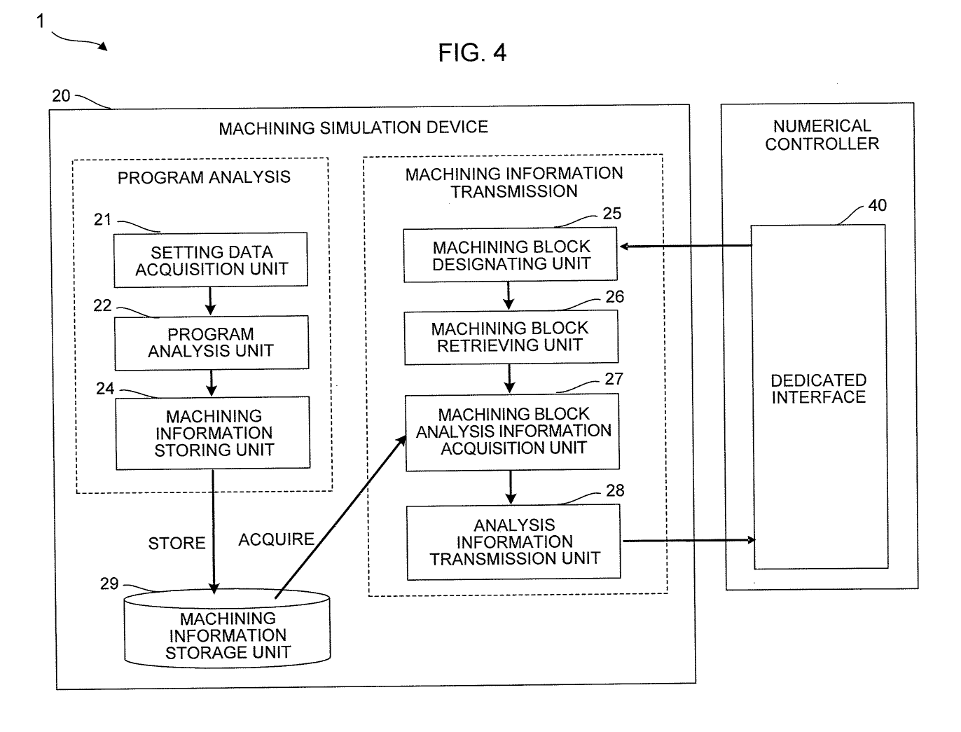

As illustrated in FIG. 4, the machining simulation device 20 can be divided into a section that analyzes a program and a section that transmits machining information.

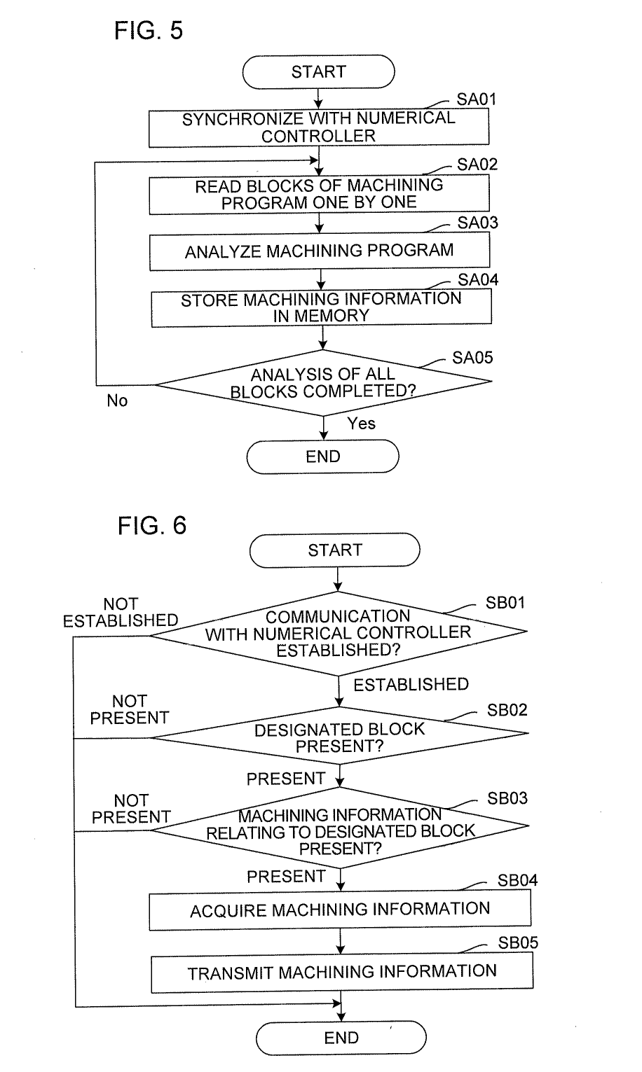

First, the program analyzing section of the machining simulation device 20 will be described with reference to the explanatory diagram of FIG. 4 and the flowchart of FIG. 5. The process illustrated in the flowchart of FIG. 5 starts when the machining program created by a user is executed on the machining simulation device 20.

[Step SA01] In order to realize analysis equivalent to the numerical controller 10, the machining simulation device 20 acquires information such as parameters and options from the numerical controller 10 using the setting data acquisition unit 21, and operates in synchronization with the numerical controller 10.

[Step SA02] A control unit of the machining simulation device 20 reads the blocks of the machining program one by one and delivers the read blocks to the program analysis unit 22.

[Step SA03] The program analysis unit 22 analyzes the machining program, and the machining information acquisition unit 23 (not illustrated in FIG. 4) acquires machining information necessary for machining and delivers the machining information to the machining information storing unit 24.

[Step SA04] The machining information storing unit 24 stores the delivered machining information in the machining information storage unit 29 provided on the memory.

[Step SA05] It is determined whether analysis of all blocks of the machining program has been completed or not. When analysis is completed, this process ends. When analysis is not completed, the process proceeds to step SA02.

The machining information stored in the machining information storage unit 29 by the above-described process is generally used as information stored so that, when machining is suspended, machining can restart from this suspended point. The machining information includes a sequence number (the number following N embedded in a program) indicating a block position of a program, a program counter (information on a currently operating block), the name or number of the program, the name or number of a parent program, information with which it is possible to determine a call start position of a parent program or the function that has been executed by a suspended block, position data, and macro variable information.

Next, the machining information transmission section of the machining simulation device 20 will be described with reference to the explanatory diagram of FIG. 4 and the flowchart of FIG. 6.

[Step SB01] The machining simulation device 20 determines whether communication with the numerical controller 10 has been established or not. When communication is established, the process proceeds to step SB02. When communication is not established, this process ends.

[Step SB02] The machining block designating unit 25 checks the presence of a designated block by referring to the dedicated interface 40 provided in the numerical controller 10. When a designated block is present, the process proceeds to step SB03. When a designated block is not present, this process ends.

[Step SB03] The machining block designating unit 25 delivers information on the designated block to the machining block retrieving unit 26. The machining block retrieving unit 26 checks, based on the information delivered from the machining block designating unit 25, if machining information that matches the designated block is stored in the machining information storage unit 29. When machining information relating to the designated block is present, the process proceeds to step SB04. When machining information relating to the designated block is not present, this process ends.

[Step SB04] The machining block analysis information acquisition unit 27 acquires the machining information relating to the designated block from the machining information storage unit 29 and delivers the machining information to the analysis information transmission unit 28.

[Step SB05] The analysis information transmission unit 28 delivers the delivered machining information to the numerical controller 10 via the dedicated interface 40.

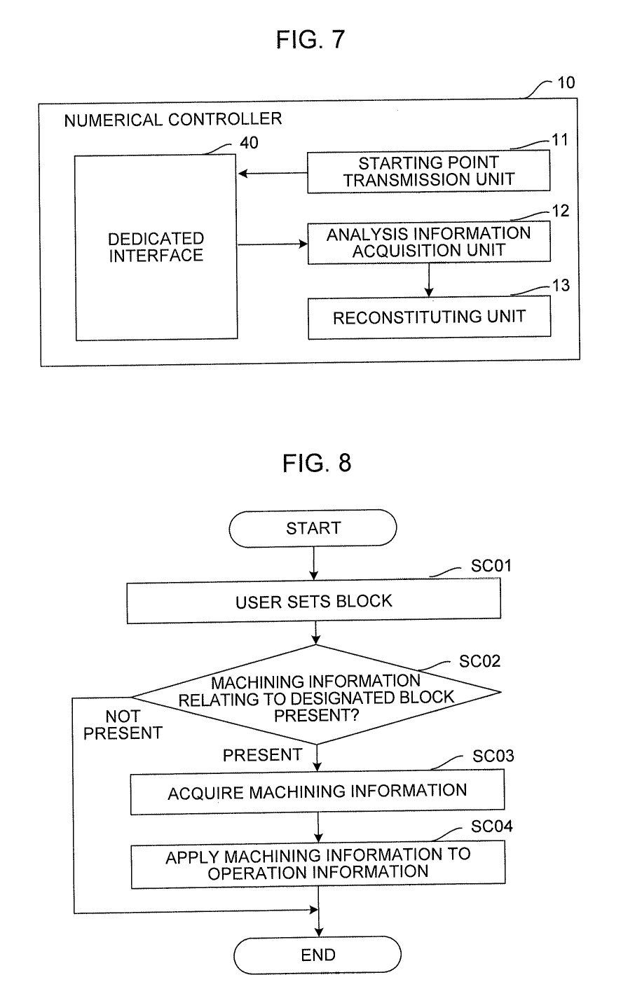

Lastly, the numerical controller 10 of the present embodiment will be described with reference to the explanatory diagram of FIG. 7 and the flowchart of FIG. 8.

[Step SC01] In the numerical controller 10, a user designates a block of the program at which machining is to be started (or restarted).

[Step SC02] The starting point transmission unit 11 sets the block designated by the user in step SC01 to the dedicated interface 40, and then, the machining simulation device 20 determines whether or not machining information relating to the block is set to the dedicated interface 40. When the machining information relating to the designated block is set, the process proceeds to step SC03. When the machining information is not set, this process ends.

[Step SC03] The analysis information acquisition unit 12 acquires the machining information set to the dedicated interface 40.

[Step SC04] The reconstituting unit 13 applies the machining information acquired by the analysis information acquisition unit 12 to operation information and ends the process.

In the numerical controller 10, when the process described in FIG. 8 ends, machining starts (restarts). Alternatively, when another program restart function is included in the numerical controller 10, it is possible to restart the function.

### Embodiment 2

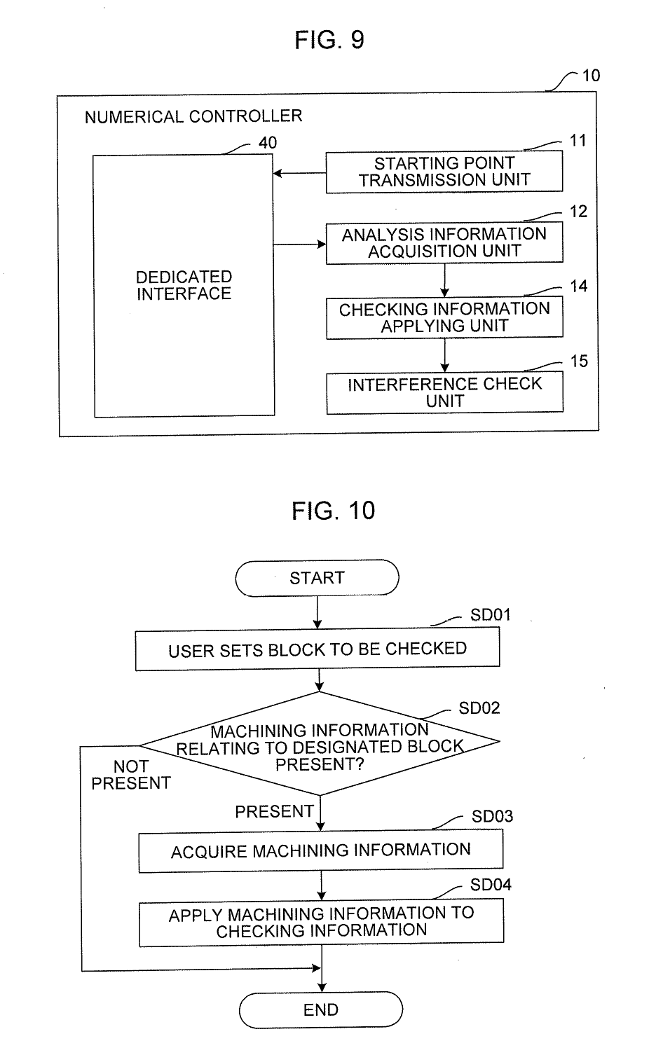

Embodiment 2 of the numerical control system 1 of the present invention will be described with reference to FIGS. 9 and 10. The numerical control system of this embodiment is used for interference check.

In the numerical control system 1 of the present embodiment, the machining simulation device 20 analyzes a machining program in advance to create machining information and stores the machining information in the machining information storage unit 29. By using the machining information stored in the machining information storage unit 29 of the machining simulation device 20 when the numerical controller 10 uses an interference check function of checking an interference between a tool and a workpiece or an interference between a tool and a machine, it is possible to check an interference in an arbitrary block in the machining program.

The processes executed on the machining simulation device 20 of the present embodiment perform the same operations as those of Embodiment 1.

The numerical controller 10 of the present embodiment will be described with reference to the explanatory diagram of FIG. 9 and the flowchart of FIG. 10. Illustration of the reconstituting unit 13 is omitted in FIG. 9.

[Step SD01] In the numerical controller 10, a user designates a block of the program to be subject to the interference check.

[Step SD02] The starting point transmission unit 11 sets the block designated by the user in step SD01 to the dedicated interface 40, and then, the machining simulation device 20 determines whether or not machining information relating to the block has been set to the dedicated interface 40. When the machining information relating to the designated block is set, the process proceeds to step SD03. When the machining information is not set, this process ends.

[Step SD03] The analysis information acquisition unit 12 acquires the machining information set to the dedicated interface 40.

[Step SD04] The checking information applying unit 14 applies the machining information acquired by the analysis information acquisition unit 12 to the information on the interference check used by an interference check unit 15.

In the numerical controller 10, when the process described in FIG. 10 ends, the interference check unit 15 starts interference check using the information on the interference check to which the machining information is applied.

### Embodiment 3

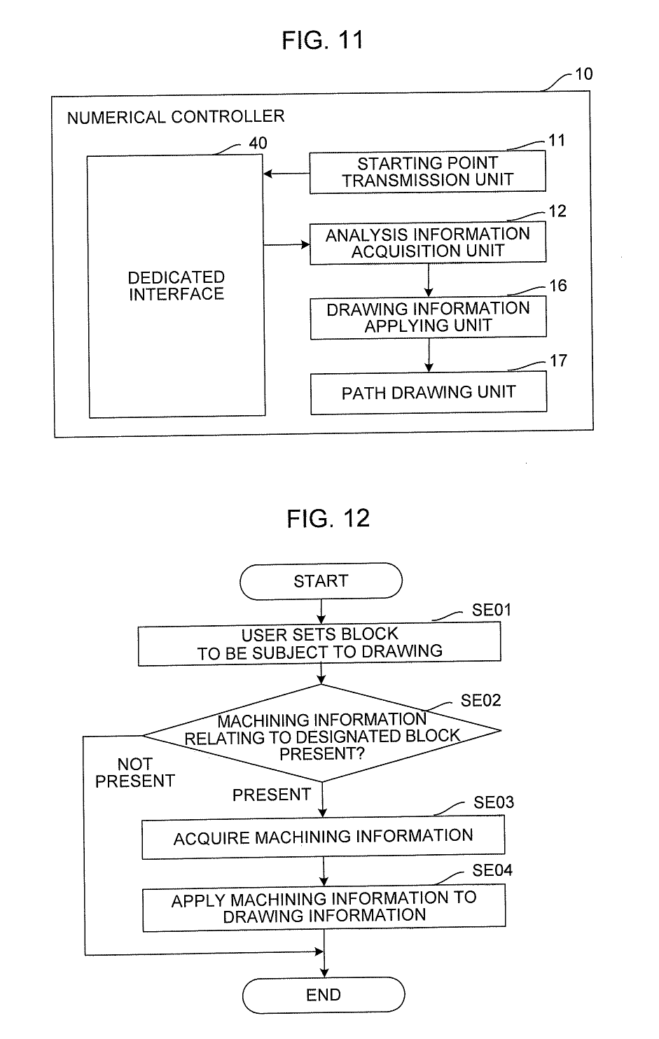

Embodiment 3 of the numerical control system 1 of the present invention will be described with reference to FIGS. 11 and 12. The numerical control system of this embodiment is used for path drawing.

In the numerical control system 1 of the present embodiment, the machining simulation device 20 analyzes a machining program in advance to create machining information and stores the machining information in the machining information storage unit 29. By using the machining information stored in the machining information storage unit 29 of the machining simulation device 20 when the numerical controller 10 uses a simulation display function such as path drawing, it is possible to draw the path of the machining program.

The processes executed on the machining simulation device 20 of the present embodiment perform the same operations as those of Embodiment 1.

The numerical controller 10 of the present embodiment will be described with reference to the explanatory diagram of FIG. 11 and the flowchart of FIG. 12. Illustration of the reconstituting unit 13 is omitted in FIG. 11.

[Step SE01] In the numerical controller 10, a user designates a block corresponding to a drawing start position of machining program to be subject to path drawing.

[Step SE02] The starting point transmission unit 11 sets the block designated by the user in step SE01 to the dedicated interface 40, and then, the machining simulation device 20 determines whether or not machining information relating to the block has been set to the dedicated interface 40. When the machining information relating to the designated block is set, the process proceeds to step SE03. When the machining information is not set, this process ends.

[Step SE03] The analysis information acquisition unit 12 acquires the machining information set to the dedicated interface 40.

[Step SE04] The drawing information applying unit 16 applies the machining information acquired by the analysis information acquisition unit 12 to path drawing information used by a path drawing unit 17.

In the numerical controller 10, when the process described in FIG. 12 ends, the path drawing unit 17 starts path drawing using the path drawing information.

### Embodiment 4

Embodiment 4 of the numerical control system 1 of the present invention will be described. The numerical control system of this embodiment is used for checking an error in the machining program.

In the numerical control system 1 of the present embodiment, since the machining simulation device 20 includes the same analysis means (the program analysis unit 22) as the numerical controller 10, when the machining program is analyzed by the machining simulation device 20, it is possible to detect the same error as the error detectable by the numerical controller 10 such as a syntax error or an interference error.

By storing error information detected by the machining simulation device 20 in the machining information, it is possible to check the error information in advance when the numerical controller 10 selects the machining program. In this way, it is possible to check errors in the machining program without performing machining.

While the embodiment of the present invention has been described, the present invention can be implemented in various forms by adding appropriate changes without being limited to the example of the above-described embodiment.

For example, in Embodiment 2, although an interference is checked for an arbitrary block designated by the user, an interference may be checked throughout the machining program. In the numerical control system 1 of the present invention, it is possible to acquire the path of the machining program in advance as described in Embodiment 3. Therefore, by comparing the path of the machining program acquired by the numerical controller 10 with information necessary for interference check such as the position or the shape of an interfering object or the position or the shape of a tool held in the numerical controller 10, it is possible to check an interference throughout the machining program.

1. A numerical control system comprising:
a numerical controller that controls a machine based on a program;
a machining simulation device that executes a machining simulation process of the program; and
a machining information storage unit that stores machining information used when machining is performed based on the program, wherein
the machining simulation device includes:
a setting data acquisition unit that acquires information necessary for the machining simulation process of the program from the numerical controller;
a program analysis unit that analyzes the program based on the information acquired by the setting data acquisition unit;
a machining information acquisition unit that acquires machining information, which is information necessary for machining, from a result of the analysis by the program analysis unit; and
a machining information storing unit that stores the machining information acquired by the machining information acquisition unit in the machining information storage unit, and
the numerical controller includes:
an analysis information acquisition unit that acquires the machining information from the machining information storage unit; and
a reconstituting unit that reconstitutes information used for actual machining based on the machining information acquired by the analysis information acquisition unit.

2. The numerical control system according to claim 1, wherein
the analysis information acquisition unit acquires machining information associated with a starting block at which execution of the program starts, the machining information being stored in the machining information storage unit,
the reconstituting unit reconstitutes information used for execution of the program based on the machining information acquired by the analysis information acquisition unit, and
the numerical controller starts machining based on the program from the starting block based on the information reconstituted by the reconstituting unit.

3. The numerical control system according to claim 1, wherein
the numerical controller further includes a checking information applying unit,
the analysis information acquisition unit acquires machining information associated with at least one block subject to an interference checking process of the program, the machining information being stored in the machining information storage unit,
the checking information applying unit applies information included in the machining information acquired by the analysis information acquisition unit to information used for the interference checking process, and
the numerical controller checks an interference in the block subject to the interference checking process based on the information used for the interference checking process to which the machining information is applied by the checking information applying unit.

4. The numerical control system according to claim 1, wherein
the numerical controller further includes a drawing information applying unit,
the analysis information acquisition unit acquires machining information associated with at least one block subject to a path drawing process of the program, the machining information being stored in the machining information storage unit,
the drawing information applying unit applies information included in the machining information acquired by the analysis information acquisition unit to information used for the path drawing process, and
the numerical controller draws a path of the block subject to the path drawing process based on the information used for the path drawing process to which the machining information is applied by the drawing information applying unit.

5. The numerical control system according to claim 1, wherein
the machining information acquisition unit acquires information on an error occurring when the program analysis unit analyzes the program as one item of the machining information, and
the numerical controller checks an error of the program based on the error information included in the machining information.

6. The numerical control system according to claim 1, wherein
the machining simulation device and the numerical controller are connected by a dedicated interface,
the machining information storage unit is provided on a memory included in the machining simulation device, and
the machining simulation device further includes an analysis information transmission unit that transmits the machining information stored in the machining information storage unit to the analysis information acquisition unit.

7. The numerical control system according to claim 1, wherein
the numerical controller includes at least two execution entities,
the machining simulation device is implemented inside the numerical controller,
execution of the program by the numerical controller and the machining simulation process of the program by the machining simulation device are executed by the execution entities differing from one another, and
the machining information storage unit is provided on a shared memory in the numerical controller.
